(19) United States
(12) Patent Application Publication
(10) Pub. No.: US 2022/0356915 A1
(43) Pub. Date: Nov. 10, 2022

(54) REINFORCED TORQUE TUBES

(71) Applicant: MEGGITT AIRCRAFT BRAKING SYSTEMS CORPORATION, AKRON, OH (US)

(72) Inventors: JOHN G. EVRARD, AKRON, OH (US); KURT BURKHALTER, AKRON, OH (US)

(21) Appl. No.: 17/736,872

(22) Filed: May 4, 2022

Related U.S. Application Data
(60) Provisional application No. 63/184,024, filed on May 4, 2021.

(51) Int. Cl. F16D 55/02

(52) U.S. Cl. CPC F16D 55/025; F16D 2055/0058

(57) ABSTRACT

Torque tubes with better total failure performance is provided. The torque tube comprises a plurality of reinforcement members made from a second material with a higher temperature strength than the first material. In preferred embodiments, the reinforcement members are tungsten rods. The reinforcement members are located concentrically around a central axis of the torque tube and each reinforcement member spans a center line of a central tube of the torque tube and spans a majority of a longitudinal length of the torque tube. In preferred embodiments, the reinforcement members are drive keys.

### CROSS REFERENCE TO RELATED APPLICATIONS

This application claims the benefit of U.S. Provisional Patent Application No. 63/184,024, filed May 4, 2021, which is incorporated herein by reference in its entirety.

### FIELD

Torque tubes are an important part of braking systems. The present application teaches reinforced torque tubes for use in braking systems and in particular, aircraft braking systems.

### BACKGROUND

Aircraft braking systems often include torque tubes. Torque tubes are typically attached to the housing piston and are inserted in the hole of the brake disc. When the aircraft brakes are engaged, the pistons press the brake discs to the torque tube which absorbs the torsional stress and releases heat. Temperatures can reach levels above what the torque tubes were originally designed for and potentially cause failure. To this end, there is a need to develop a design for a torque tube than can better withstand these high temperature incidents. There is a need for a reinforced torque tube design and methods of making the same.

### SUMMARY OF THE EMBODIMENTS

Objects of the present patent document are to provide a torque tube for braking systems and in particular, an aircraft braking system. The torque tube is reinforced to better withstand elevated temperatures. In preferred embodiments, the torque tubes are reinforced by inserting tungsten rods around the circumference of the torque tube.

In preferred embodiments, a torque tube is made from a first material. Coupled to the torque tube are a plurality of reinforcement members made from a second material with a higher temperature strength than the first material. In preferred embodiments, the reinforcement members are located concentrically around a central axis of the torque tube and each reinforcement member spans a center line of a central tube of the torque tube. Also preferably, the reinforcement members span a majority of a longitudinal length of the torque tube.

In some embodiments, each reinforcement member in the plurality of reinforcement members is positioned along an outer wall of the torque tube.

Although the reinforcement members can be made from many different materials, in preferred embodiments the reinforcement members are made from tungsten and the torque tube body is made from stainless steel.

In various different embodiments, the reinforcement members can take on many different shapes or forms however, preferably, the plurality of reinforcing members are rods.

The reinforcement members may be coupled to the body of the torque tube in various different ways but in most embodiments, each reinforcement member is located within a passage in an outer wall of the torque tube. Even more preferably, each reinforcement member in the plurality of reinforcement members is located within a drive key, or is clipped around the outside of a drive key, or is somehow attached to the drive key.

The number and configuration of the reinforcement members can change depending on the requirements of the application. However, in most applications, the plurality of reinforcement members are spaced symmetrically about the central axis and equidistant from adjacent reinforcement members.

In different embodiments, the plurality of reinforcement members may be inserted into the torque tube from either end. Preferably, the reinforcement members are inserted into the torque tube from an end opposite a flange end.

The reinforcement members preferably span a majority of the longitudinal length of the torque tube. In even more preferred embodiments, the reinforcement members span 75% or 80 or more of the longitudinal length of the torque tube.

Although rods are the typical shape for reinforcement members, in some embodiments, clips may be used. In some embodiments. the plurality of reinforcement members are clips and each clip slides over a portion of an exterior structure of the torque tube.

### BRIEF DESCRIPTION OF THE DRAWINGS

FIG. 1 illustrates a plan view of a torque tube with reinforcing rods inserted concentrically around the central axis of the torque tube.

FIG. 2 illustrates a partially exploded view of the section A-A from FIG. 1.

FIG. 3 illustrates a close-up view of the top portion of the exploded section of FIG. 2.

FIG. 4 illustrates an isometric semi-transparent view of a torque tube with reinforcing rods inserted.

FIG. 5 illustrates an isometric wireframe view of a torque tube with reinforcing rods inserted and one reinforcing rod exploded.

FIG. 6 illustrates an isometric view of a torque tube with reinforcing rods inserted.

FIG. 7 illustrates a plan view of a torque tube with reinforcing rods inserted concentrically around the central axis from the outboard side of the torque tube.

FIG. 8 illustrates a partially exploded view of the section B-B from FIG. 7.

FIG. 9 illustrates a semi-transparent isometric view of a torque tube with reinforcing rods inserted.

FIG. 10 illustrates an isometric wireframe view of the torque tube of FIG. 9.

FIG. 11 illustrates an isometric wireframe view of a torque tube with hidden lines shown in dashed lines.

FIG. 12 illustrates an isometric wireframe exploded view of the torque tube of FIG. 11.

FIG. 13 illustrates a plan view of a torque tube with reinforcing clips arranged concentrically around the central axis of the torque tube.

FIG. 14 illustrates an exploded view of the section A-A from FIG. 13.

FIG. 15 illustrates an isometric view of a torque tube with reinforcing clips arranged concentrically around the central axis of the torque tube.

### DETAILED DESCRIPTION OF THE DRAWINGS

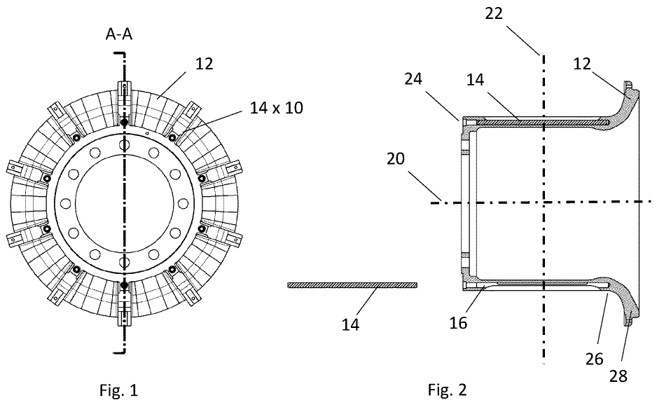

This invention consists of strategically placing reinforcing members with superior elevated temperature strength within a torque tube. FIG. 1 illustrates a top-down view of an embodiment of a torque tube 12 with ten reinforcing members 14 inserted concentrically around the central axis 20 of the torque tube 12. In the embodiment shown in FIG. 1, the reinforcing members 14 are rods but in other embodiments, the reinforcing members may be clips, clamps or other forms.

As may be seen in FIGS. 1 and 2, in preferred embodiments, the reinforcing members 14 are placed concentrically around the central axis 20 and run longitudinally along the outer wall of the torque tube 12. Reinforcing members 14 may be staggered at different diameters from the central axis but run essentially longitudinally along the torque tube 12. Reinforcing members 14 may be placed at even intervals around the circumference of the torque tube 12, or may be spaced in other configurations. In preferred embodiments, the spacing is always consistent and preferably symmetric about the central axis 20.

Looking at FIG. 2, the torque tube is comprised of a central tube that runs from a first end 24 to a second end 26. Axis 22 has been added to show the centerline of the central tube. A flange 28 is formed on the second end 26 of the torque tube. As may be appreciated from FIG. 2, the reinforcement members 14 span the central axis 22. In preferred embodiments, the reinforcement members 14 span at least a majority or more of the longitudinal axis 20 of the central tube. In even more preferred embodiments, the reinforcement members 14 span at least 75%, 80% or 90% or more of the longitudinal axis of the central tube.

In preferred embodiments, the reinforcing members 14 are rods made from tungsten but the reinforcing members 14 may be any shape and made from any material. In embodiments designed to increase temperature resistance, the reinforcing members 14 should be made from a material with an elevated temperature strength. In general, a metal becomes weaker and more ductile at elevated temperatures. Most ferrous metals have a maximum strength at approximately 200° C. the strength of non-ferrous metals is generally at a maximum at room temperature.

Materials with a higher melt temperature, as compared to those that typically comprise the main structure of a torque tube, are able to supply load resistance for a much longer duration during or after a rejected takeoff (RTO) or other extreme energy condition has been completed.

The following materials may be used for the reinforcing members 14 due to their higher temperature strength and melt point. Tungsten, Tantalum, Molybdenum, Chromium, Vanadium, Titanium, Nimomic alloys, Stelilite, Hastelloy, Inconel, Stainless Steel, Nichrome, Heat-Resisting allow steels. The material used for the reinforcing members 14 needs to be selected based on the application and the material used for the torque tube body.

As used herein “temperature strength” means “strength at an elevated temperature.” Ultimate strength (at elevated temperature) is the dominant criteria. Some materials at extremely elevated temperatures display little difference between ultimate and yield strength. For increased effectiveness, the reinforcing material must maintain some strength beyond the melting point of the baseline torque tube material.

The reinforcing members 14 may be attached or coupled to the torque tube 12 in a variety of ways. In some embodiments, the reinforcement members 14 are located in passages within the outer wall of the central tube of the torque tube 12. The passages may completely encase the reinforcement members 14 or may just partially encase them.

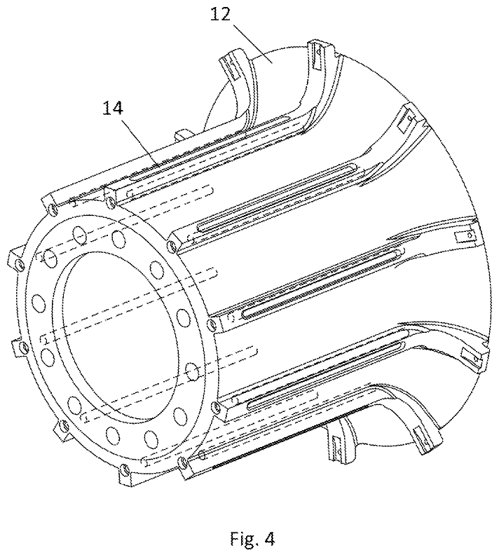

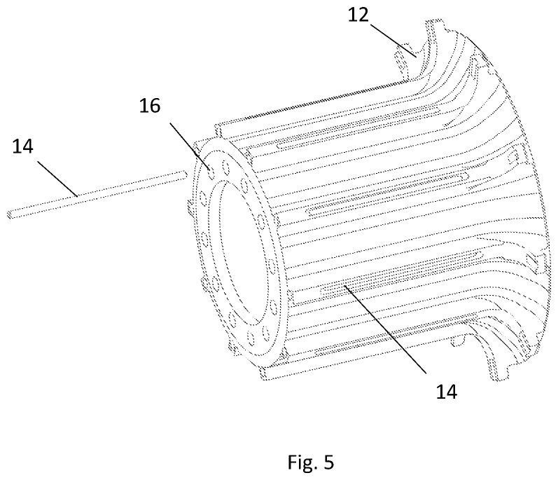

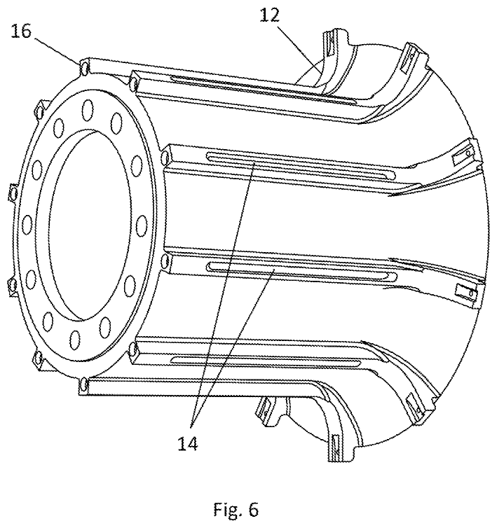

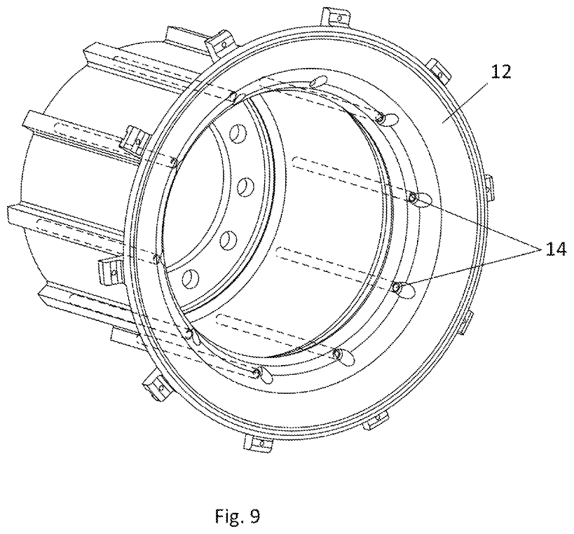

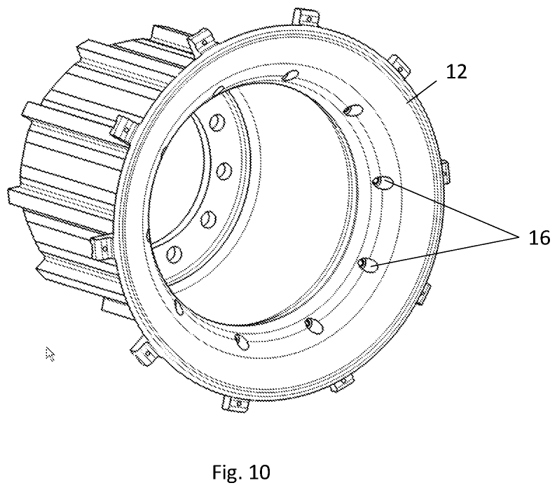

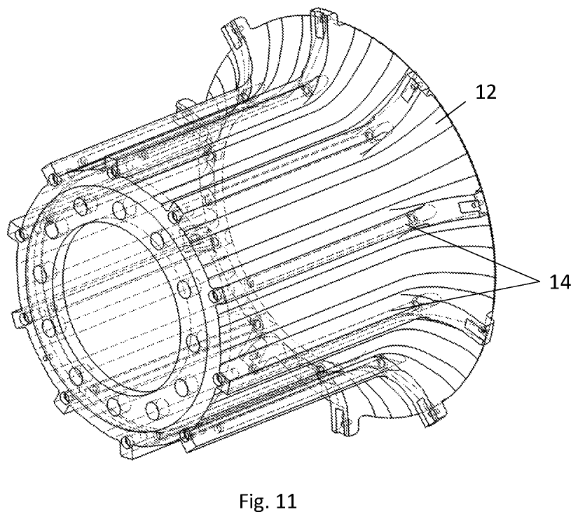

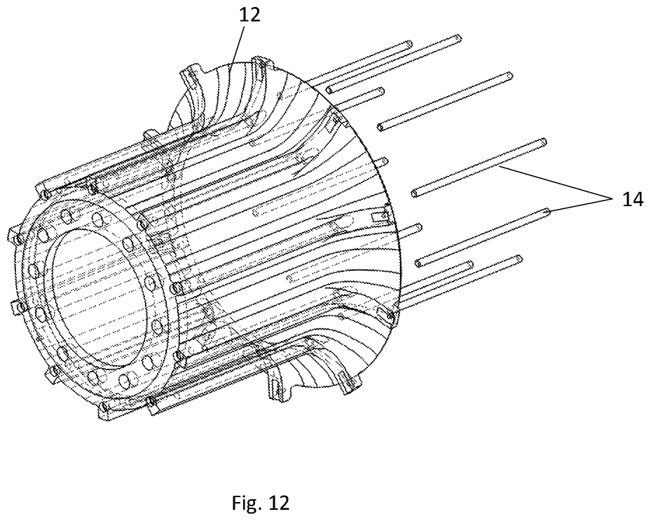

Torque tubes typically have “keys.” Typically, these torque tube keys have straight or angled sides to react against mating “key slots” at the inner diameter of the pressure plate and stationary disks. As may be seen in FIGS. 1-12, in preferred embodiments, the reinforcing members 14 may be placed inside the drive keys in order to provide enhanced resistance to braking torque under severe conditions. By locating the reinforcement members 14 in the drive keys, torque transfer from the brake stationary disks to the reinforcement is ensured.

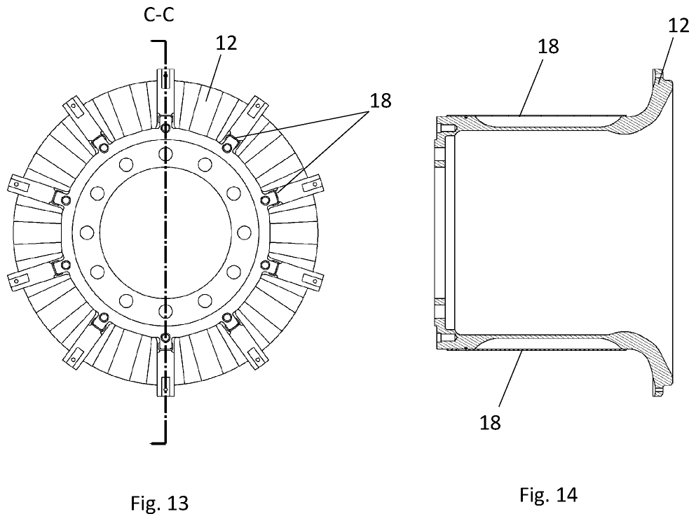

To this end, in the embodiments herein, the keys are reinforced by the reinforcement members 14, but are still present. Under normal use, the key provides a flat bearing surface for the disks. At extreme temperatures, the flat bearing surface could melt in which case the reinforcement members 14 carry that bearing load. A cylindrical bearing surface is not desirable for service conditions because of higher localized stresses in the disks, but for the single use ultimate condition such as the RTO, it can be acceptable. FIGS. 13-15 depict a design which shows high temperature reinforcement which has flat sides and therefore can be used as directly as the bearing surface with the disks.

Axial displacement of the reinforcing rods is constrained at each end by mechanical connection to the torque tube (threads, interference fit, welding, swaging, keying, etc.). Reinforcing members 14 do not necessarily need to be in every torque tube key. The number and placement of the reinforcing members 14 can be determined by the load required to be carried.

The shape of the reinforcing members 14 may be cylindrical (as shown in FIG. 1) or may be of other cross sections (rectangular, trapezoidal, etc.) and still provide similar benefits. Cylindrical rods are likely to be the most cost-effective solution.

In preferred embodiments, the reinforcing members 14 are used in combination with torque tubes for carbon brakes. Carbon brakes can generate higher temperatures than steel brakes. Steel brakes melt a heat sink first, essentially providing a “fuse” for the torque tube. However, in other embodiments, reinforcing members 14 may be used with any type or material brake.

Using reinforcing members is beneficial for many reasons. In most cases, it is not practical to produce the entire torque tube from a “superior material” for cost and manufacturing reasons as well as other considerations such as strength and weight.

In high temperature situations, torque tube melting tends to occur first at the approximate center of the worn heatsink. Ends of the torque tube can remain intact (not melted) and capable of additional load. Reinforcement members 14 are designed to span that melted gap between the intact areas.

Torque tubes for carbon brakes are typically manufactured from high temperature capable steel alloys. Titanium is used in some applications. To provide improved melt resistance, the reinforcing material needs to melt at a higher temperature than the base torque tube material. The idea here is not to make the base torque tube out of aluminum or other low temperature materials, but to extend the current state-of-the-art to allow more energy/load. In preferred embodiments the reinforcing members 14 are made from Tungsten or Tungsten alloys but in other embodiments, Titanium, Titanium allows, Ceramics, Cermets and/or reinforced carbon-carbon are some possible materials to be used.

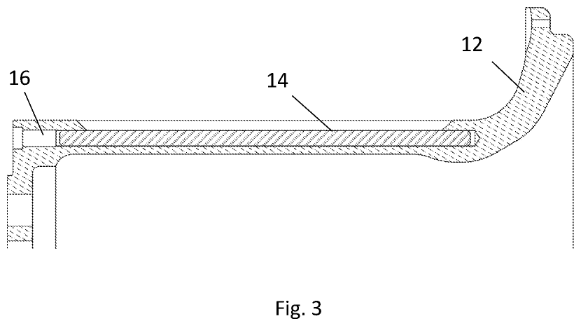

In preferred embodiments, rods are installed within the torque tube drive keys through bolt holes which subsequently capture the rod within the torque tube key. FIG. 3 illustrates a partial cross-section with a reinforcing rod 14 installed into the drive key through bolt holes 16. The bolt hole 16 is typically used for mounting bolts, which attach the torque tube 12 to a brake housing. The diameter of the reinforcing rod 14 is driven by the brake mounting bolt size 16 because they are co-axial.

Essentially, the drive keys are reinforced internally with superior temperature materials. However, in other embodiments, new holes may be drilled or machined out of the torque tube to add the reinforcing members 14. These additional holes or slots in the torque tube may be designed into a new torque tube build or may be added as a re-work to an existing design.

As may be seen in FIGS. 1-6, the reinforcing members 14 are installed in the exterior wall of the torque tube 12 housing.

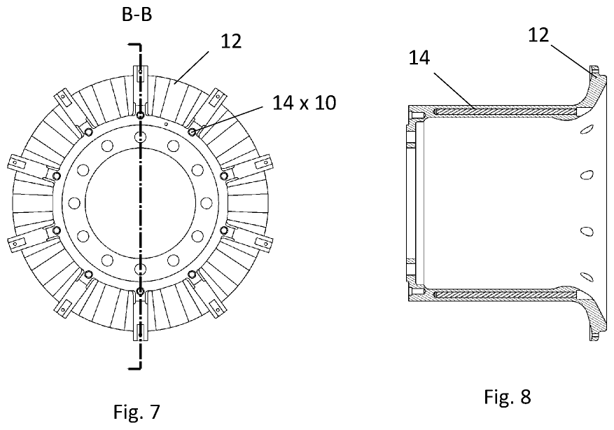

FIG. 7 and FIG. 8 illustrate another embodiment of a torque tube 12 with reinforcing rods 14 where the reinforcing rods 14 are inserted from the opposite side of the torque tube to the embodiments in FIGS. 1-6. In embodiments such as those shown in FIGS. 7 and 8, the bolt holes no longer need to be coaxial with the mounting bolt holes and therefore, the reinforcing ride diameter is no longer driven by the mounting bolt hole size. However, in such embodiments, some means needs to be added to capture the reinforcing rods 14 in place. In different embodiments, staking, welding or capping off the hole 16 may be used. In other embodiments, other means of capturing the rods 14 may be used.

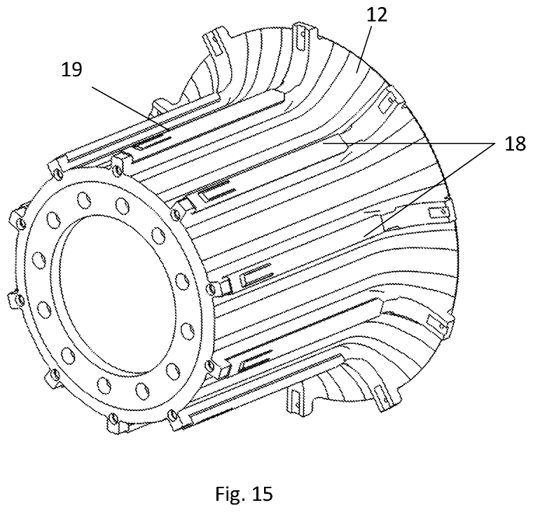

FIG. 15 illustrates an isometric view of a torque tube with reinforcing clips 18 arranged concentrically around the central axis of the torque tube. As may be seen in FIG. 15, rather than have reinforcing members that fit inside holes or slots in the torque tube 12, the reinforcing members 18 slide over an outside member of the torque tube structure. The clips may be held in place with a tab 19.

As may be appreciated, any number of reinforming members 14 may be added to a single torque tube 12. In some embodiments, four reinforcing members 14 may be added. In other embodiments, 6, 8, 10, 12 or 14 may be added. Odd numbers may be used in some embodiments as well. Ideally, the reinforcing members 14 are radially spaced an equal distance from adjacent reinforcing members 14.

What is claimed is:

1. A torque tube made from a first material comprising:
a plurality of reinforcement members made from a second material wherein the second material has a higher temperature strength than the first material and wherein the plurality of reinforcement members are located concentrically around a central axis of the torque tube and each reinforcement member in the plurality of reinforcement members spans a center line of a central tube of the torque tube and spans a majority of a longitudinal length of the torque tube.

2. The torque tube of claim 1, wherein each reinforcement member in the plurality of reinforcement members is positioned along an outer wall of the torque tube.

3. The torque tube of claim 1 wherein the second material is tungsten.

4. The torque tube of claim 2, wherein the first material is stainless steel.

5. The torque tube of claim 1, wherein the plurality of reinforcing members are rods.

6. The torque tube of claim 4, wherein each reinforcement member in the plurality of reinforcement members is located within a passage in an outer wall of the torque tube.

7. The torque tube of claim 1, wherein each reinforcement member in the plurality of reinforcement members is located within a drive key.

8. The torque tube of claim 1, wherein the plurality of reinforcement members are spaced symmetrically about the central axis and equidistant from adjacent reinforcement members.

9. The torque tube of claim 1, where the plurality of reinforcement members are inserted into the torque tube from an end opposite a flange end.

10. The torque tube of claim 1, wherein the plurality of reinforcement members spans 80% or more of the longitudinal length of the torque tube.

11. The torque tube of claim 1, wherein the plurality of reinforcement members are clips and each clip slides over a portion of an exterior structure of the torque tube.

12. A torque tube made from a first material comprising:
a plurality of reinforcement members made from a second material wherein the second material has a higher temperature strength than the first material and wherein the plurality of reinforcement members are located concentrically around a central axis of the torque tube and each reinforcement member in the plurality of reinforcement members spans a center line of a central tube of the torque tube and spans 75% or more of a longitudinal length of the torque tube.

13. The torque tube of claim 12, wherein each reinforcement member in the plurality of reinforcement members is positioned along an outer wall of the torque tube.

14. The torque tube of claim 12, wherein the second material is tungsten.

15. The torque tube of claim 12, wherein the plurality of reinforcing members are rods.

16. The torque tube of claim 12, wherein each reinforcement member in the plurality of reinforcement members is located within a drive key.

17. The torque tube of claim 12, wherein the plurality of reinforcement members are spaced symmetrically about the central axis and equidistant from adjacent reinforcement members.

18. The torque tube of claim 12, wherein the plurality of reinforcement members are clips and each clip slides over a portion of an exterior structure of the torque tube.

19. A torque tube made from a first material comprising:
a plurality of tungsten rods wherein tungsten has a higher temperature strength than the first material and wherein the plurality tungsten rods are drive keys located concentrically around a central axis of the torque tube and each tungsten rod in the plurality of tungsten rods spans a center line of a central tube of the torque tube and spans 75% or more of a longitudinal length of the torque tube and where each reinforcement member in the plurality of reinforcement members is located inside a drive key.

20. The torque tube of claim 19, wherein the plurality of tungsten rods are spaced symmetrically about the central axis and equidistant from adjacent tungsten rods.
